(19) United States
(12) Patent Application Publication
(10) Pub. No.: US 2004/0262386 A1
(43) Pub. Date: Dec. 30, 2004

(54) Instore and remote-hosted solution for retail promotion optimization using moveable "devices" having components such as price checkers, printers, and controllers

(76) Inventors: Frank Abrams, Toronto (CA); Stuart Wayne Manley, Thornhill (CA)

Correspondence Address: FRANK ABRAMS, 70 BAY HAMPTON CRES, THORNHILL, ON, L4J 7G9, CA

(21) Appl. No.: 10/827,459

(22) Filed: Apr. 19, 2004

Related U.S. Application Data
(60) Provisional application No. 60/463,438, filed on Apr. 17, 2003.
(60) Provisional application No. 60/534,991, filed on Jan. 9, 2004.

(51) Int. Cl. G06K 15/00

(52) U.S. Cl. 235/383

(57) ABSTRACT

An instore and remote-hosted solution for Retail Promotion Optimization using moveable “devices”, said “devices” having components such as price checkers, printers, displays and controllers. In a Retail store, the solution processes the scan of a barcode, or a button push, then outputs targeted text, graphics, messages and/or coupons. The system includes algorithms and logic associated with evaluating in real-time, from external and internal databases, multiple factors and conditions such as location, time, inventory, demand, elasticity, product life cycle and shelf life, profit margins, inventory turns, cost of goods sold, as well as identifying customers, shoppers or users, with or without collecting descriptive information, followed by the subsequent issuance of customized text, graphics, messages and/or coupons for a current or future purchase. The moveable “device”s are positioned at various locations within a Retail store commonly called the Point of Decision, namely the point where Shoppers make the final decision on what to buy, for those familiar in this business; these locations being for example, the door entry, the end of a merchandise aisle, commonly called an “end-cap” for those familiar in this business, merchandise shelves, outside displays and customer service desks. The solution maintains real-time 2 way communications, between a remote host, remote database, an instore system and the moveable “devices”.

I hereby incorporate by reference (1) Provisional Application Title: Scansave 60/463,438 filed on Apr. 17^{th} 2003, and (2) Provisional Application Title: mopods 60/534,991 filed on Jan. 9^{th} 2004.

The following Patents are listed as reference:

| | |
|---|---|
| “Microsoft” 6,061,692 | “Catalina” 6,424,949 |
| “Copient” 20040064368 | “Catalina” 6,584,448 |
| “Catalina” 6,282,516 | “Catalina” 6,684,195 |
| “Retail Multimedia Corp” 5,918,211 | “NCR” 6,502,076 |
| “Specialty Equipment Co. Inc.” 4,738,042 | “Catalina” 6,484,146 |
| “Ad Response MicroMarketing Corp” 6,076,068 | “NCR” 6,334,110 |
| “Catalina” 5,173,851 | “Micro Enhancement Int” 5,857,175 |
| “Catalina” 5,832,457 | “IBM” 6,505,773 |
| “Catalina” 6,307,958 | “Catalina” 6,377,935 |
| “Catalina” 6,321,210 | “SoftCard Systems Inc.” 6,354,492 |
| “Catalina” 6,334,108 | “Matthias; John T.” 6,151,587 |
| “Catalina” 6,377,935 | “OneClip.com Inc.” 6,076,069 |
| “OneClip.com” 6,041,309 | Chumbley; Gregory R. 5,535,118 |
| “Digital Broadband Applications Corp.” 5,946,646 | “Totom Enterprises, Inc.” 5,097,981 |
| “Smolen; Daniel T.” 5,915.243 | “Gempsy France” D486,827 |
| “Gregory; Edward M.” 5,909,673 | “NCR Corp” D480,397 |
| “Catalina” 5,612,868 | “NCR Corp” 6,621,407 |
| “The Standard Registry Co.” 6,691,915 | “NCR Corp” 6,430,704 |
| “Symbol Technologies Inc.” 6,616,049 | “NCR Corp” 6,415,263 |
| “InfoSpace, Inc.” 6,237,145 | “NCR Corp” 5,710,416 |
| “Intel Corp.” 6,075,971 | “NCR Corp” 6,043,751 |
| “SoftCard Systems, Inc.” 6,012,038 | “Lin, Ching-Fang;” 20020131405 |
| “Ad Response MicroMarketing Corp” 5,882,735 | “Alexander, Bruce; Bahneman, Liem” 20020075307 |
| “Environmental Products Corp” 5,557,721 | |

### STATEMENT REGARDING FED SPONSORED R&D

The Applicant has not received any Federal sponsored R&D funding

### REFERENCE TO SEQUENCE LISTING, A TABLE OR A COMPUTER PROGRAM LISTING APPENDIX

7 Drawings included

### BRIEF SUMMARY OF THE INVENTION

The present invention is a Retail Promotion Optimization solution that uses hardware such as price checkers and printers to deliver targeted text, graphics, messages and/or coupons, based on a scanned input or a button push

The solution is non-interactive in so far as it does not include a menuing system, nor is it content-rich; rather it is a system to deliver targeted offers, slide shows, information, and coupons to Shoppers where they make their decision to buy.

Specifically, in its primary embodiment, moveable “device”s are positioned at various locations within a Retail store commonly called a Point of Decision FIG. 3 (56), these locations being for example, the door entry, the end of a merchandise aisle, commonly called an “end-cap” for those familiar in this business, merchandise shelves, outside displays and customer service desks. Then, the present invention takes the scan of a barcode as a data input, or a button push, then outputs text, graphics, messages and/or coupons for use on the Shopper's current visit.

### BRIEF DESCRIPTION OF THE DRAWINGS

A more complete appreciation of the invention and many of the attendant advantages thereof will readily obtained as the same becomes better understood by reference to the following detailed descriptions when considered in connection with the accompanying drawings, wherein:

FIG. 1 is a block diagram of a retail store computer device architecture, composed of checkout devices and information system, along with a remote retailer database

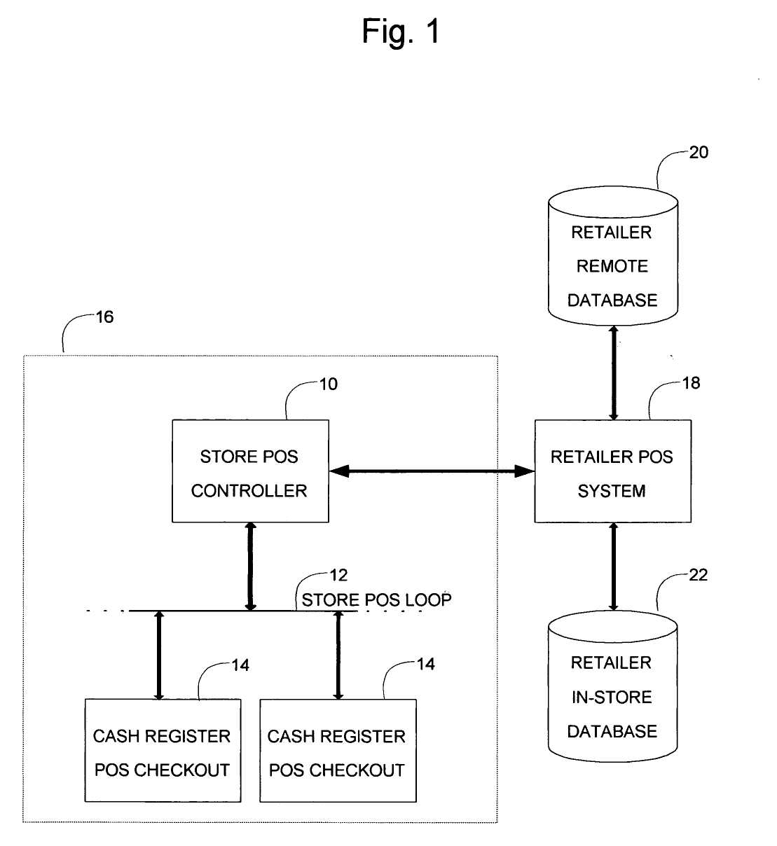

FIG. 2 is a block diagram of an information system architecture in a retail store information system, supplemented with a remote database, a remote 3rd party database, a network, and components of the present invention namely; instore system, remote host and remote database

FIG. 3 is a block diagram of a network, secure web pages and components of the present invention namely; instore system, remote host, remote database, and an array of moveable “devices” situated at locations refered elsewhere as the point of decision, said locations being merchandise aisles, entry doors, service desks, outside displays, end-cap displays and exit doors. In addition, moveable “devices” are indicated at POS checkout as represented in FIG. 1

FIG. 4 is a block diagram of components of the present invention namely; cameras, instore system, as well as the components of moveable “devices”, said components of moveable “devices” being input screen, input button(s), display screen, input scanner, input RFID, input magstripe, as well as printer(s).

FIG. 5 is a flowchart representing the operation of a preferred embodiment of present invention

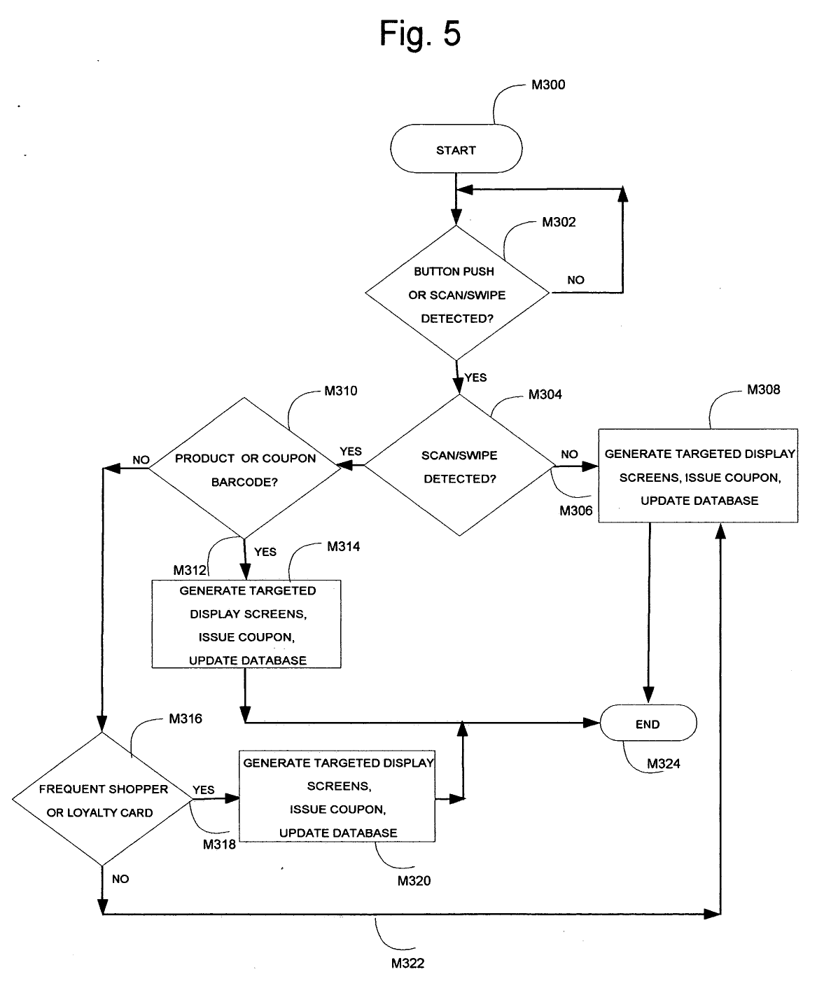

FIG. 6 is a flowchart representing the recovery operation of present invention in the event of a disruption of electric power,

FIG. 7 is a flowchart representing the operation of present invention in the event of a change in the network address of the instore system or moveable “device”.

### DETAILED DESCRIPTION OF THE DRAWINGS

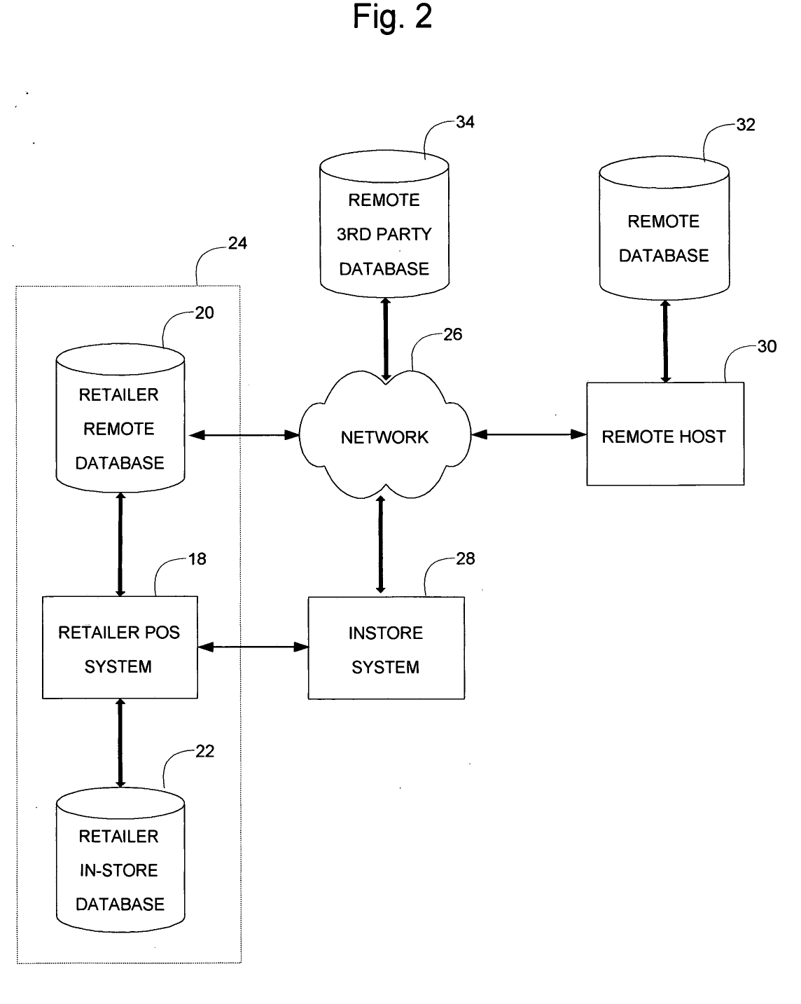

Detailed Description of the Drawings

| Figure | Label # | Label | Description |
|---|---|---|---|
| 1 | 10 | STORE POS CONTROLLER | PART OF THE SYSTEM THAT CONTROLS THE CASH |
| | | | REGISTER POS CHECKOUTS 14 IN A STORE |
| 1 | 12 | STORE POS LOOP | THE INSTORE NETWORK THAT CONNECTS ALL THE |
| | | | CHECKOUTS 14 TO THE STORE POS CONTROLLER 10 |
| 1 | 14 | CASH REGISTER POS | PRODUCTS ARE SCANNED AND TOTALED AT THE CASH |
| | | CHECKOUT | REGISTER POS CHECKOUT |
| 1 | 16 | STORE POS SYSTEM | THE CHECKOUT FUNCTION PART OF THE RETAIL POS |
| | | | SYSTEM 18 |
| 1, 2 | 18 | RETAILER POS SYSTEM | THE STORE SYSTEM THAT OPERATES THE CHECKOUT |
| | | | FUNCTION AND OTHER FUNCTIONS; CONNECTED TO |
| | | | THE INSTORE SYSTEM 28 (FIG. 2) THE PRESENT |
| | | | INVENTION'S INSTORE SYSTEM OBTAINS DATA, |
| | | | MEANING TRANSACTION AND SHOPPER INFORMATION, |
| | | | DIRECTLY FROM THE RETAILER POS SYSTEM BY MEANS |
| | | | OF A 3^{RD} PARTY NETWORK POS CARD, OR BY MEANS OF |
| | | | A WEB-SERVICE OR NETWORK REQUEST TO RETAILER |
| | | | REMOTE DATABASE 20, OR RETAILER IN-STORE |
| | | | DATABASE 22. |
| 1, 2 | 20 | RETAILER REMOTE | REMOTE RETAILER DATABASE THAT IS NOT LOCATED |
| | | DATABASE | IN-STORE, STORES DATA FROM RETAILER POS SYSTEM |
| | | | 18; CONNECTED TO THE NETWORK 26 (FIG. 2) |
| 1, 2 | 22 | RETAILER IN-STORE | RETAILER DATABASE THAT IS LOCATED IN-STORE, |
| | | DATABASE | STORES DATA FROM RETAILER POS SYSTEM 18 |
| 2 | 24 | RETAILER INFORMATON | THE AGGREGATED OF THE RETAILER POS SYSTEM AND |
| | | SYSTEMS | RETAILER REMOTE DATABASE |
| 2, 3 | 26 | NETWORK | NETWORK OF ANY TYPE AND DESCRIPTION INC. |
| | | | INTERNET, PRIVATE NETWORKS, FRAME SATELLITE, |
| | | | WIRELESS ETC. |
| 2, 3, 4 | 28 | INSTORE SYSTEM | INSTORE SYSTEM COMPRISED OF DEVICES SUCH AS |
| | | | COMPUTERS, CONTROLLERS, 3^{RD} PARTY NETWORK POS |
| | | | CARDS, WIRELESS BASE STATIONS AND OTHER |
| | | | EQUIPMENT TO SUPPORT THE OPERATION OF THE |
| | | | SOLUTION |
| 2, 3 | 30 | REMOTE HOST | THE SYSTEM HOSTED THAT ENCOMPASSES A CLIENT |
| | | | CAMPAIGN PORTAL SERVER TO SETUP MARKETING, |
| | | | PROMOTION OPTIMIZATION AND COUPON DELIVERY, |
| | | | AS WELL AS A DEVICE MANAGER SERVER TO OPERATE |
| | | | MARKETING, PROMOTION OPTIMIZATION, AND COUPON |
| | | | DELIVERY, AS WELL AS A DIRECT CONNECTION TO A |
| | | | PRIVATE REMOTE DATABASE SERVER, ALL IN A SECURE |
| | | | AND MISSION-CRITICAL ENVIRONMENT |
| 2, 3 | 32 | REMOTE DATABASE | A DATABASE |
| 2 | 34 | REMOTE 3RD PARTY | A DATABASE |
| | | DATABASE | |
| 3 | 36 | SECURE WEB PAGES | SECURE WEB PAGES THAT CLIENTS USE TO ACCESS THE |
| | | | CLIENT CAMPAIGN PORTAL SERVER TO SETUP |
| | | | MARKETING, PROMOTION OPTIMIZATION AND COUPON |
| | | | DELIVERY ON THE REMOTE HOST |
| 3 | 44 | MOVEABLE “DEVICE” AT | A COMBINATION OF COMPONENTS INCLUDING |
| | | END-CAP DISPLAY AND | INDUSTRY STANDARD PRICE CHECKERS AND |
| | | EXIT | PRINTER(S), FORMING A MOVEABLE “DEVICE”, WHICH |
| | | | IS LOCATED AT AN END-CAP DISPLAY AT THE END OF A |
| | | | MERCHANDISE AISLE, OR LOCATED AT THE EXIT DOOR |
| 3 | 46 | MOVEABLE “DEVICE” AT | A COMBINATION OF COMPONENTS INCLUDING |
| | | SERVICE DESK & OUTSIDE | INDUSTRY STANDARD PRICE CHECKERS AND |
| | | DISPLAY | PRINTER(S), FORMING A MOVEABLE “DEVICE”, WHICH |
| | | | IS LOCATED AT AN END-CAP DISPLAY AT A SERVICE |
| | | | DESK, OR LOCATED AT AN OUTSIDE DISPLAY |
| 3 | 48 | MOVEABLE “DEVICE” AT | A COMBINATION OF COMPONENTS INCLUDING |
| | | MERCHANDISE AISLE & | INDUSTRY STANDARD PRICE CHECKERS AND |
| | | ENTRY | PRINTER(S), FORMING A MOVEABLE “DEVICE”, WHICH |
| | | | IS LOCATED IN A MERCHANDISE DISPLAY, OR LOCATED |
| | | | AT AN ENTRY DOOR |
| 3 | 50 | MOVEABLE “DEVICE” AT | A COMBINATION OF COMPONENTS INCLUDING |
| | | POS CHECKOUT | INDUSTRY STANDARD PRICE CHECKERS AND |
| | | | PRINTER(S), FORMING A MOVEABLE “DEVICE”, WHICH |
| | | | IS LOCATED AT A CHECKOUT AT THE POS |
| 3, 4 | 54 | MOVABLE “DEVICES” | THE CONNECTION S USED TO CONNECT THE MOVABLE |
| | | WIRELESS OR WIRED | “DEVICES” TO THE INSTORE SYSTEM |
| | | CONNECTIONS | |
| 3 | 56 | LOCATION DESCRIPTION: | A DISTINCT LOCATION FOR MOVEABLE “DEVICE” |
| | | ANY MOVEABLE “DEVICES” | SPECIFICALLY WHERE SHOPPERS DECIDE WHAT TO |
| | | LOCATED AT A POINT OF | BUY, AS OPPOSED TO THE POS CHECKOUT WHERE |
| | | PURCHASE DECISION NOT | SHOPPERS PAY FOR PURCHASES THEY HAVE ALREADY |
| | | AT POS CHECKOUT | DECIDED TO BUY |
| 4 | 60 | “DEVICE” COMPONENT: | PRINTER COMPONENT WHICH IS ADDED TO INDUSTRY |
| | | PRINTER(S) | STANDARD PRICE CHECKERS, TO MAKE A MOVEABLE |
| | | | “DEVICE”. |
| 4 | 62 | “DEVICE” COMPONENT: | INPUT COMPONENT SUCH AS A SCANNER, RFID OR |
| | | INPUT FROM SCANNER, | MAGSTRIPE READER, THAT MAKES UP PART OF AN |
| | | RFID, MAGSTRIPE | INDUSTRY STANDARD PRICE CHECKER, WHICH WHEN |
| | | | COMBINED WITH A PRINTER MAKES A MOVEABLE |
| | | | “DEVICE”. |
| 4 | 64 | “DEVICE” COMPONENT: | DISPLAY COMPONENT SUCH AS A SCREEN OR |
| | | DISPLAY SCREEN | TOUCHSCREEN, THAT MAKES UP PART OF AN INDUSTRY |
| | | | STANDARD PRICE CHECKER, WHICH WHEN COMBINED |
| | | | WITH A PRINTER MAKES A MOVEABLE “DEVICE”. |
| 4 | 66 | “DEVICE” COMPONENT: | DISPLAY COMPONENT SUCH AS AN INPUT BUTTON, OR |
| | | INPUT SCREEN, INPUT | TOUCHSCREEN BUTTON IMAGE, THAT MAKES UP PART |
| | | BUTTON(S) | OF AN INDUSTRY STANDARD PRICE CHECKER, WHICH |
| | | | WHEN COMBINED WITH A PRINTER MAKES A MOVEABLE |
| | | | “DEVICE”. |
| 4 | 68 | COMPONENTS THAT | COMPONENTS THAT TOGETHER MAKE UP INDUSTRY |
| | | TOGETHER MAKE UP | STANDARD PRICE CHECKERS, SPECIFICALLY LACKING |
| | | INDUSTRY STANDARD | AN INTEGRATED PRINTER |
| | | PRICE CHECKERS, | |
| | | SPECIFICALLY LACKING AN | |
| | | INTEGRATED PRINTER | |
| 4 | 80 | COMPONENTS THAT | COMPONENTS THAT TOGETHER MAKE UP MOVEABLE |
| | | TOGETHER MAKE UP | “DEVICE” AS DESCRIBED IN PRESENT INVENTION, |
| | | MOVEABLE “DEVICE” AS | COMPRISED OF INDUSTRY STANDARD PRICE CHECKER |
| | | DESCRIBED IN PRESENT | AND A PRINTER COMPONENT |
| | | INVENTION | |
| 5 | M300 | START | |
| 5 | M302 | BUTTON PUSH OR | YES - THE READY STATE OF THE PRESENT INVENTION |
| | | SCAN/SWIPE | HAS BEEN INTERRUPTED AND THERE HAS BEEN AN |
| | | DETECTED? | INPUT; |
| | | | NO - THE PRESENT INVENTION REMAINS IN A READY |
| | | | STATE |
| 5 | M304 | SCAN/SWIPE | YES - THE PRESENT INVENTION DETERMINES THAT THE |
| | | DETECTED? | MOVEABLE “DEVICE” HAS A SCAN OR A SWIPE INPUT; |
| | | | NO - BY DEFAULT IT IS A BUTTON PUSH |
| 5 | M306 | PROCESSING OF | |
| | | BUTTON PUSH INPUT | |
| 5 | M308 | GENERATE TARGETED | THE MOVEABLE “DEVICES” ISSUES A COUPON AND |
| | | DISPLAY SCREENS, | DISPLAYS SCREENS AS DETERMINED BY THE PRESENT |
| | | ISSUE COUPON, | INVENTION |
| | | UPDATE DATABASE | |
| 5 | 310 | PRODUCT OR COUPON | YES - THE PRESENT INVENTION DETERMINES THAT THE |
| | | BARCODE? | MOVEABLE “DEVICE” HAS A SCAN OR A SWIPE INPUT |
| | | | THAT IS A PRODUCT OR COUPON BARCODE; |
| | | | NO - BY DEFAULT IT IS A FREQUENT SHOPPER OR |
| | | | LOYALTY CARD, OR AN UNKNOWN SCAN/SWIPE |
| 5 | M312 | PROCESSING OF | |
| | | PRODUCT OR COUPON | |
| | | BARCODE | |
| | | SCAN/SWIPE | |
| 5 | M314 | GENERATE TARGETED | THE MOVEABLE “DEVICES” ISSUES A COUPON AND |
| | | DISPLAY SCREENS, | DISPLAYS SCREENS AS DETERMINED BY THE PRESENT |
| | | ISSUE COUPON, | INVENTION |
| | | UPDATE DATABASE | |
| 5 | M316 | FREQUENT SHOPPER | YES - THE PRESENT INVENTION DETERMINES THAT THE |
| | | OR LOYALTY CARD, OR | MOVEABLE “DEVICE” HAS A FREQUENT SHOPPER OR |
| | | UNKNOWN | LOYALTY CARD INPUT; |
| | | SCAN/SWIPE? | NO - BY DEFAULT IT IS AN UNKNOWN SCAN/SWIPE |
| 5 | M318 | PROCESSING OF | |
| | | SHOPPER OR LOYALTY | |
| | | CARD SCAN/SWIPE | |
| 5 | M320 | GENERATE TARGETED | THE MOVEABLE “DEVICES” ISSUES A COUPON AND |
| | | DISPLAY SCREENS, | DISPLAYS SCREENS AS DETERMINED BY THE PRESENT |
| | | ISSUE COUPON, | INVENTION |
| | | UPDATE DATABASE | |
| 5 | M322 | PROCESSING OF | |
| | | UNKNOWN | |
| | | SCAN/SWIPE | |
| 5 | M324 | END | |
| 6 | M400 | START | |
| 6 | M402 | HAS ELECTRIC POWER | YES - THE READY STATE OF THE PRESENT INVENTION |
| | | BEEN DISRUPTED? | HAS BEEN INTERRUPTED AND THERE HAS BEEN A |
| | | | POWER DISRUPTION; |
| | | | NO - THE PRESENT INVENTION REMAINS IN |
| | | | A READY STATE |
| 6 | M404 | IS INSTORE SYSTEM | YES - PROCEED TO NEXT LEVEL OF RECOVERY; |
| | | ONLINE TO REMOTE | NO - ESCALATE PROBLEM |
| | | HOST? | |
| 6 | M406 | IS INSTORE SYSTEM | YES - PROCEED TO NEXT LEVEL OF RECOVERY CHECK |
| | | ONLINE TO DEVICES? | AND RESTORE DEVICE COMMUNICATIONS; |
| | | | NO - ESCALATE PROBLEM |
| 6 | M408 | CHECK AND RESTORE | |
| | | DEVICE | |
| | | COMMUNICATIONS | |
| 6 | M410 | ARE DEVICE | YES - PROCEED TO NEXT LEVEL OF RECOVERY SETUP |
| | | COMMUNICATIONS | AND TEST DEVICES; |
| | | RESTORED? | NO - ESCALATE PROBLEM |
| 6 | M412 | SETUP AND TEST | |
| | | DEVICES | |
| 6 | M414 | TEST OK? | YES - END; |
| | | | NO - ESCALATE PROBLEM |
| 6 | M416 | ESCALATE PROBLEM | WHEN PROBLEM ESCALATED, CYCLE THROUGH AGAIN |
| 6 | M418 | IF POWER DISRUPTED | |
| | | OR PROBLEM | |
| | | ESCALATED, CYCLE | |
| | | THROUGH AGAIN | |
| 6 | M498 | END | |
| 7 | M430 | START | |
| 7 | M432 | DEVICE OR INSTORE | YES - THE READY STATE OF THE PRESENT INVENTION |
| | | SYSTEM IP ADDRESS | HAS BEEN INTERRUPTED AND THERE HAS BEEN A |
| | | CHANGED? | CHANGE IN THE IP ADDRESS OF DEVICES OR THE |
| | | | INSTORE SYSTEM; |
| | | | NO - THE PRESENT INVENTION REMAINS IN A READY |
| | | | STATE |
| 7 | M434 | IF THERE HAS BEEN A | |
| | | CHANGE IN THE IP | |
| | | ADDRESS OF DEVICES | |
| | | OR THE INSTORE | |
| | | SYSTEM PROCEED TO | |
| | | GET IP ADDRESS | |
| 7 | M436 | GET NEW IP ADDRESS | |
| | | AND TRANSMIT TO | |
| | | INSTORE SYSTEM AND | |
| | | REMOTE HOST | |
| 7 | M438 | TRANSMIT NEW IP | |
| | | ADDRESS TO DEVICES | |
| 6, 7 | M404 | IS INSTORE SYSTEM | YES - PROCEED TO NEXT LEVEL OF RECOVERY; |
| | | ONLINE TO REMOTE | NO - ESCALATE PROBLEM |
| | | HOST? | |
| 6, 7 | M406 | IS INSTORE SYSTEM | YES - PROCEED TO NEXT LEVEL OF RECOVERY CHECK |
| | | ONLINE TO DEVICES? | AND RESTORE DEVICE COMMUNICATIONS; |
| | | | NO - ESCALATE PROBLEM |
| 6, 7 | M408 | CHECK AND RESTORE | |
| | | DEVICE | |
| 6, 7 | M410 | ARE DEVICE | YES - PROCEED TO NEXT LEVEL OF RECOVERY SETUP |
| | | COMMUNICATIONS | AND TEST DEVICES; |
| | | RESTORED? | NO - ESCALATE PROBLEM |
| 6, 7 | M412 | SETUP AND TEST | |
| | | DEVICES | |
| 6, 7 | M414 | TEST OK? | YES - END; |
| | | | NO - ESCALATE PROBLEM |
| 6, 7 | M416 | ESCALATE PROBLEM | WHEN PROBLEM ESCALATED, CYCLE THROUGH AGAIN |
| 7 | M488 | IF POWER DISRUPTED | |
| | | OR PROBLEM | |
| | | ESCALATED, CYCLE | |
| | | THROUGH AGAIN | |
| 6, 7 | M498 | END | |

### DESCRIPTION OF THE INVENTION

The present invention in its primary embodiment, in a Retail store, processes the scan of a barcode as a data input, then conducts a query of a database, then selectively outputs text, graphics, messages and/or coupons.

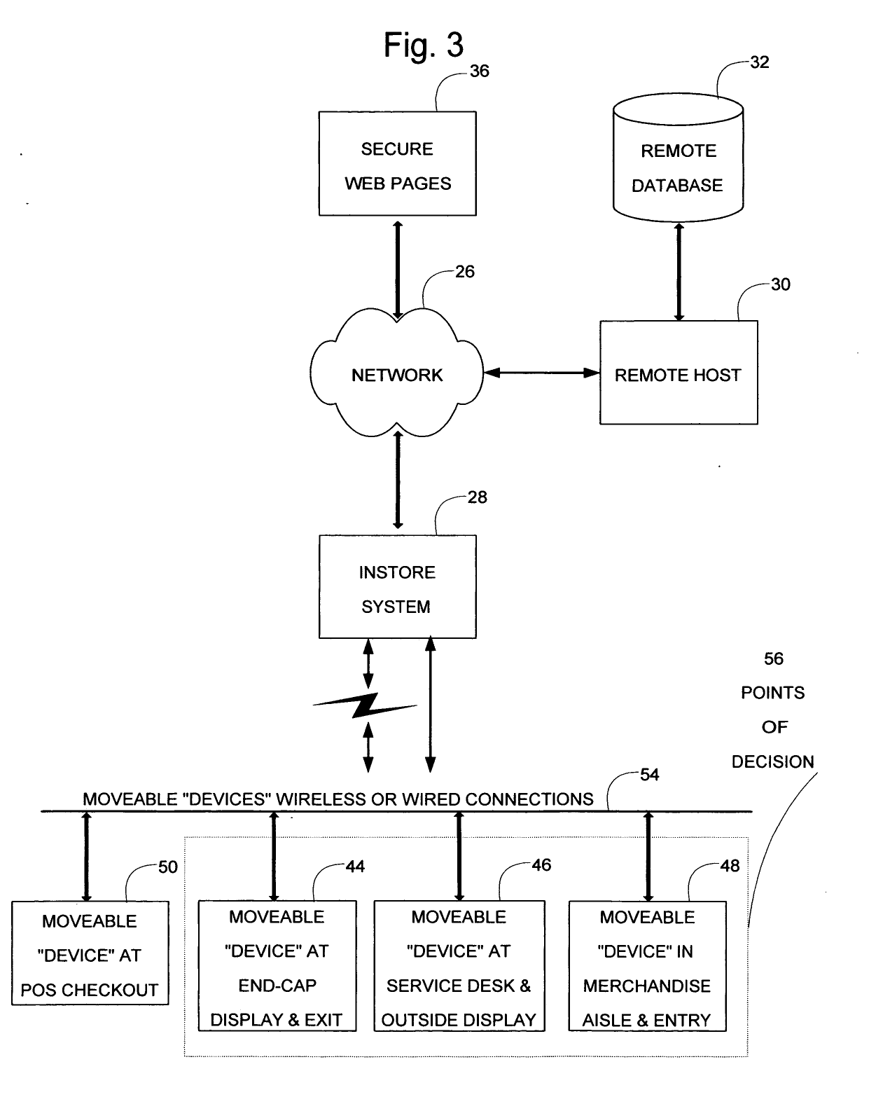

Specifically, in its primary embodiment, moveable “device”s are positioned at various locations within a Retail store commonly called a Point of Decision FIG. 3 (56), namely the point where Shoppers make the final decision on what to buy, for those familiar in this business; these locations being for example, the door entry, the end of a merchandise aisle, commonly called an “end-cap” for those familiar in this business, merchandise shelves, outside displays and customer service desks. Then, the present invention takes the scan of a barcode as a data input, then conducts a query of a database, then selectively outputs text, graphics, messages and/or coupons for the Shopper's current visit The present invention references existing solutions, components and systems commonly used for other applications, specifically, devices commonly called “Price Checkers” or “Price Verifiers” which are used by Retailers to give Shoppers a display of a product's price, when the product barcode is scanned at the device.

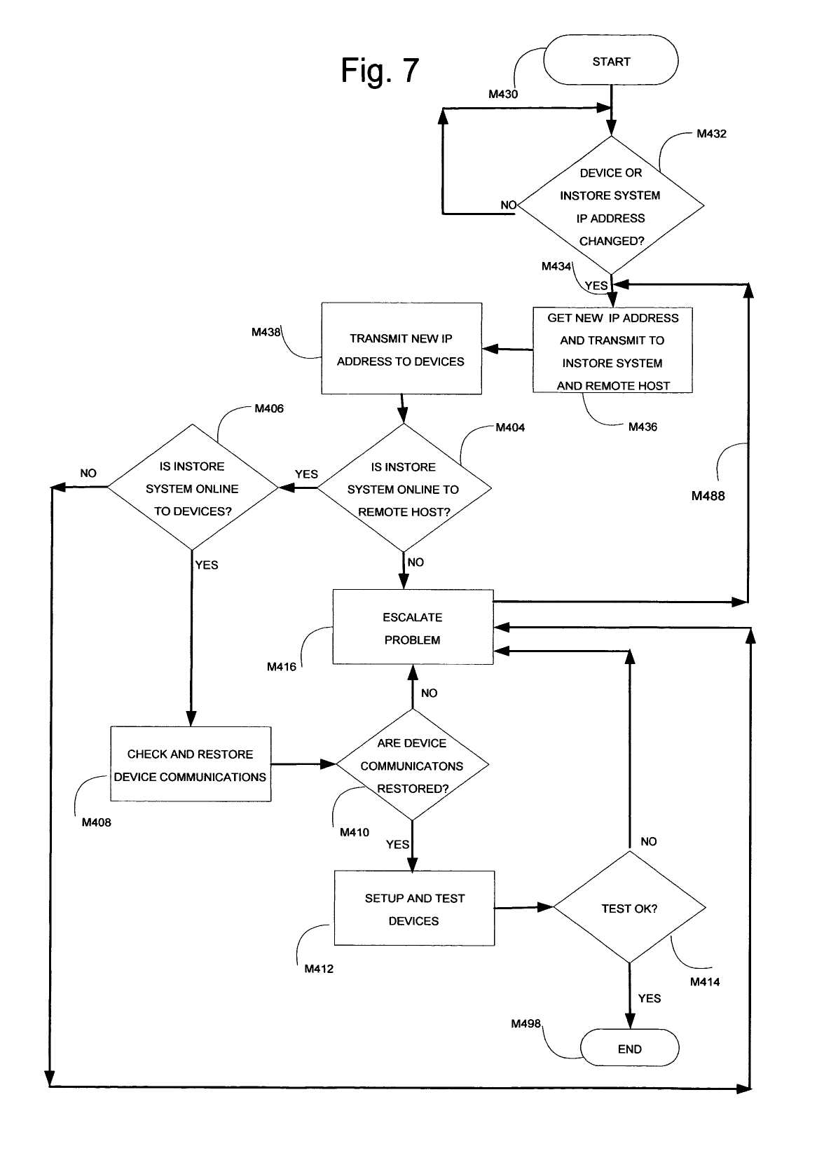

These devices when combined with printers and controllers, and configured for wireless communications, form a moveable “device” as described in the present invention. The present invention thus extends the original use of said existing solutions, components and systems by adding a printer to obtain coupon printing capability, this capability specifically enabled by the present invention's addition of hardware controllers, being a component of the moveable “device” The present invention further extends the original use of said existing solutions, components and systems by conducting 2 way communications, by assigning a network address, commonly called an IP address for those familiar in this business in order to identify the “device” on the network, this capability specifically enabled by the present invention's use of network addressing to establish and maintain 2 way remote wireless communications with the moveable “device”. FIG. 7

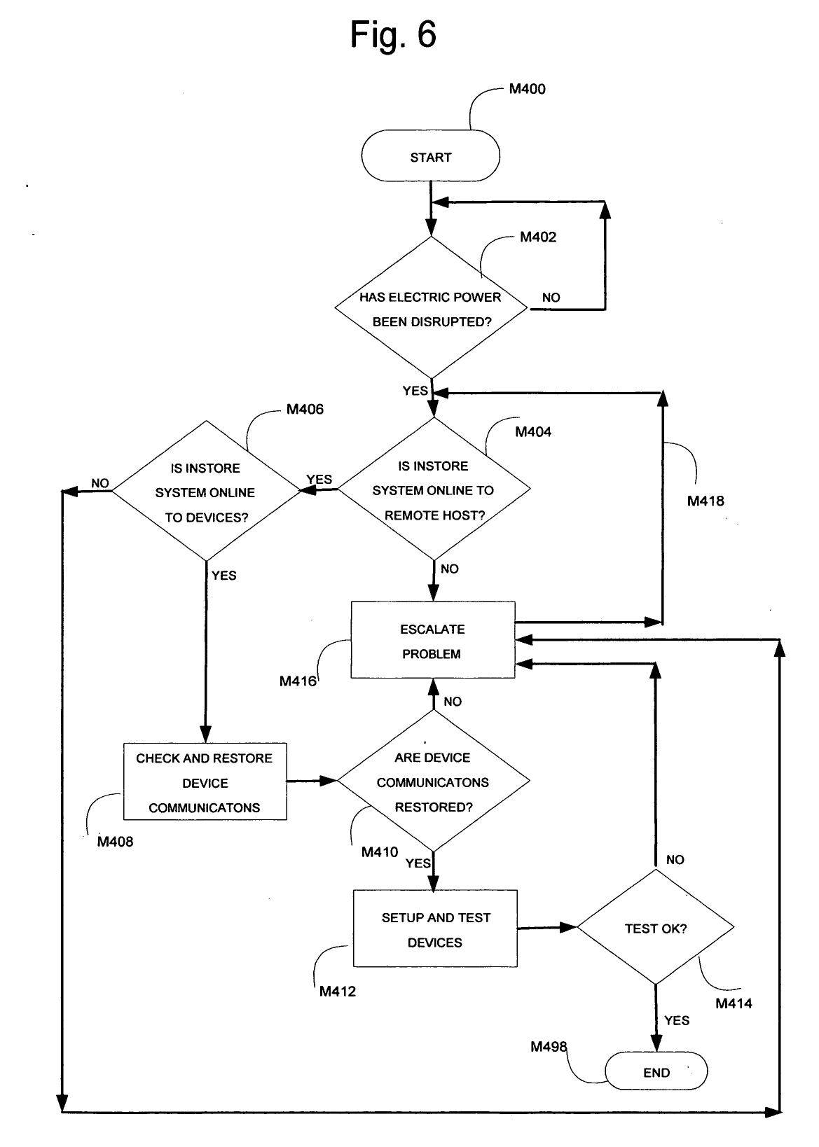

The present invention further extends the original use of said existing solutions, components and systems by detecting interruptions in power supply in order to maintain live communications, this capability specifically enabled by the present invention's use of network communications to establish and maintain 2 way remote wireless communications with the moveable “device”. FIG. 6 The present invention, in these and other ways is a non-obvious system for delivering targeted coupons and incentives, advertising messages, text displays of product and other information, based on existing solutions, components and systems.

The present invention is also unique in that most prior claims refer to marketing activities at the POS checkout FIG. 3 (50), but not at a Point of Decision FIG. 3 (56), namely the point where Shoppers make the final decision on what to buy, for those familiar in this business; these locations being for example, the door entry, the end of a merchandise aisle, commonly called an “end-cap” for those familiar in this business, merchandise shelves, outside displays and customer service desks, and in those cases where reference is made to the Point of Decision, the marketing activities are inextricably linked to the Shopper passing through the checkout to complete the marketing activity, such as checking a database of the Shopper's information to deliver an electronic promotional offer which in the present invention is not the case. In the present invention the coupon is issued and the Shopper redeems it as any other coupon. The present invention is also unique in that prior claims that do refer to marketing activities at a Point of Decision FIG. 3 (56), are generally interactive kiosks with menu screens so Shopper's can actively select menu items to obtain information or offers of some type, which in the present invention is not the case. In the present invention, the coupon is issued based on the solution's decision system and the Shopper does not have any opportunity to use a menu to make a coupon selection, with the exception of pushing a button to a activate the generation of a coupon, in lieu of scanning a product barcode or scanning a frequent shopper or loyalty card.

In addition, the present invention in a different embodiment is positioned just in front of the POS checkout lane FIG. 3 (50), to take the scan of a barcode as a data input, then conducts a query of a database, that database specifically NOT being the transaction POS checkout system, then selectively outputs text, graphics, messages and/or coupons. This embodiment is different from prior claims in that offers generated by the present invention, are independent of the actual basket of goods to be paid for at the POS checkout, and the present invention is not integrated with the POS checkout system. Notwithstanding this uniqueness from prior claims, this embodiment is different from the present invention's operations at the Point of Decision, because in this embodiment the shopper has most likely made their purchase decision already, and is checking out, and any promotional coupon issued would be for the Shopper's future visit.

What is claimed as new and desired to be secured by Letters Patent of the United States is:

1. a system comprising embedded and remote software, databases, and remote hosts, instore systems, and devices; such as price checkers, barcode scanners, display screens and printers that accept a scan as an input, queries internal and external databases using proprietary algorithms and logic, then, outputs targeted text, graphics, messages, and/or coupons to said devices in Retail stores, specifically a remotely-hosted system FIG. 2 (30) system that includes algorithms and logic associated with evaluating in real-time, from external and internal databases, multiple factors and conditions such as location, time, inventory, demand, elasticity, product life cycle and shelf life, profit margins, inventory turns, cost of goods sold, as well as identifying customers, shoppers or users, with or without collecting descriptive information, followed by the subsequent issuance of customized text, graphics, messages and/or coupons for a current or future purchase, along with the management and restart of multiple moveable “devices, from failures or power outages FIG. 6, and changes in network addresses FIG. 7

2. The system of claim 1. above in one embodiment where, moveable “device”s are positioned at various locations FIG. 3 (44,46,48) within a Retail store commonly called a Point of Decision FIG. 3 (56), namely the point where Shoppers make the final decision on what to buy, for those familiar in this business; these locations being for example, the door entry, the end of a merchandise aisle, commonly called an “end-cap” for those familiar in this business, merchandise shelves, outside displays and customer service desks.

3. The system of claim 1. in another embodiment where multiple internal and external data sources are sourced in real-time.

4. The system of claim 1. in another embodiment where the targeted text, graphics, messages, and/or coupons are specifically for a purchase on the Shopper's current visit.

5. The system of claim 1. in another embodiment where the targeted text, graphics, messages, and/or coupons are specifically for a purchase on the Shopper's future visit.

6. The system of claim 1. in another embodiment where Retailer data on product sales velocity before, during and after a sales promotion, and product profit margins before, during and after a sales promotion, are tracked and analyzed.

7. The system of claim 1. in another embodiment where the present invention enables in-store lookup of rewards or loyalty points balances, from a scan of a frequent shopper/loyalty card, followed by the secure instant redemption of rewards or loyalty points by printing a secure ticket or tender.

8. The system of claim 1. in another embodiment where the present invention enables the data input to be a button push instead of a scan.

9. The system of claim 1. in another embodiment where the present invention enables Shoppers to enter identification data such as a barcode over the Internet, then pre-select discount offers over the Internet and then when at a store location, scan or enter identification data such as a barcode, smart card or pin number, then print the pre-selected coupons.

10. The system of claim 1. in another embodiment where the present invention enables Shoppers to enter identification data such as a barcode over the Internet, then pre-select discount offers over the Internet and then when at a store location, scan or enter identification data such as a barcode, smart card or pin number at the POS checkout to claim the pre-selected discount offers.

11. The system of claim 1. in another embodiment where the present invention enables users to manage and change text and graphics displays both for manual operations and schedule-based automated operations. These operations can be transactional (meaning both the database(s) and the device will be successfully updated simultaneously), or non-transactional.

12. The system of claim 1. in another embodiment where the present invention enables a paperless electronic coupon to be redeemed at the POS checkout.

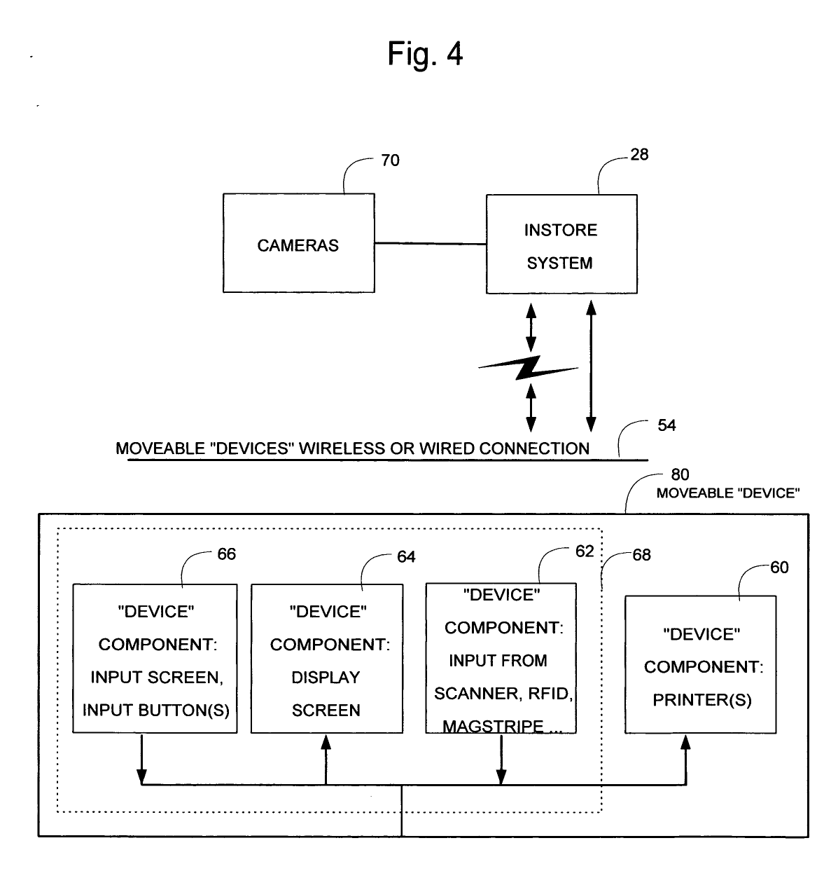

13. Claim 2 A second claim that the present invention, in the following ways is a non-obvious system for delivering targeted coupons and incentives, advertising messages, text displays of product and other information, based on existing solutions, components and systems used for other applications, specifically, devices commonly called “Price Checkers” or “Price Verifiers” which are used by Retailers to give Shoppers a display of a product's price, when the product barcode is scanned at the device. The present invention thus claims an extension beyond the original use of said existing solutions, components and systems by adding a printer to obtain coupon printing capability, this capability specifically enabled by the present invention's addition of hardware controllers, being a component of the moveable “device”, and extends the original use of said existing solutions, components and systems by conducting 2 way communications, by assigning a network address, commonly called an IP address for those familiar in this business in order to identify the “device” on the network, this capability specifically enabled by the present invention's use of network addressing establish and maintain 2 way remote wireless communications with the moveable “device” FIG. 7, and extends the original use of said existing solutions, components and systems by detecting interruptions in power supply in order to maintain live communications, this capability specifically enabled by the present invention's use of network communications to establish and maintain 2 way remote wireless communications with the moveable “device” FIG. 6, and extends the original use of said existing solutions, components and systems by adding a camera to allow remote visual confirmation of the moveable “device” status FIG. 4 (70).

14. Claim 3 A third claim that the present invention is unique, useful and non-obvious in that most prior claims referenced, refer to marketing activities at the POS checkout FIG. 3 (50), but not at a Point of Decision FIG. 3 (56), namely the point where Shoppers make the final decision on what to buy, for those familiar in this business; these locations being for example, the door entry, the end of a merchandise aisle, commonly called an “end-cap” for those familiar in this business, merchandise shelves, outside displays and customer service desks, and in those cases where reference is made to the Point of Decision, the marketing activities are inextricably linked to the Shopper passing through the checkout to complete the marketing activity, such as checking a database of the Shopper's information to deliver an electronic promotional offer which in the present invention is not the case. In the present invention the coupon is issued and the Shopper redeems it as any other coupon, and that prior claims that do refer to marketing activities at a Point of Decision FIG. 3 (56), are generally interactive kiosks with menu screens so Shopper's can actively select menu items to obtain information or offers of some type, which in the present invention is not the case. In the present invention, the coupon is issued based on the solution's decision system and the Shopper does not have any opportunity to use a menu to make a coupon selection, with the exception of pushing a button to activate the generation of a coupon, in lieu of scanning a product barcode or scanning a frequent shopper or loyalty card.

15. The system of claim 3. in another embodiment, that notwithstanding referenced prior claims related to marketing at the POS, the moveable “devices” described in the present invention is positioned just in front of the POS checkout lane FIG. 3 (50), to take the scan of a barcode as a data input, then conducts a query of a database, that database specifically NOT being the transaction POS checkout system, then selectively outputs text, graphics, messages and/or coupons. This embodiment is different from prior claims in that offers generated by the present invention, are independent of the actual basket of goods to be paid for at the POS checkout, and the present invention is not integrated with the POS checkout system. Notwithstanding this uniqueness from prior claims, this embodiment is different from the present invention's operations at the Point of Decision, because in this embodiment the shopper has most likely made their purchase decision already, and is checking out, and any promotional coupon issued would be for the Shopper's future visit.
